(19) United States
(12) Patent Application Publication
(10) Pub. No.: US 2024/0296288 A1
(43) Pub. Date: Sep. 5, 2024

(54) METHODS AND SYSTEMS FOR DETERMINING WHETHER A TEXT WAS PRODUCED BY A HUMAN OR BY ARTIFICIAL INTELLIGENCE

(71) Applicant: Copyleaks, Inc., Stamford, CT (US)

(72) Inventors: Yehonatan BITTON, Sde Nehemia (IL); Elad BITTON, Sde Nehemia (IL); Alon YAMIN, New York, NY (US)

(21) Appl. No.: 18/177,473

(22) Filed: Mar. 2, 2023

(51) Int. Cl. G06F 40/30; H04L 9/32

(52) U.S. Cl. CPC G06F 40/30; H04L 9/3263

(57) ABSTRACT

A method of evaluating whether a text was written by a human or an artificial intelligence includes tracking inputs to a computer during generation of the text; storing metadata from the tracked inputs, said metadata including time of entry of inputs and patterns of revisions of the inputs; comparing the metadata to statistical values for time of entry and patterns of revisions during composition in human-generated text and in artificial intelligence generated text; and, on the basis of the scoring, issuing a determination whether the text was written by a human or by an artificial intelligence.

### FIELD OF THE INVENTION

The present application relates to the field of forensic analysis of text, and more specifically, but not exclusively, to methods and systems for determining whether a text was produced by a human or by an artificial intelligence.

### BACKGROUND OF THE INVENTION

As the capabilities of artificial intelligence (AI) increase, artificial intelligence computer programs are becoming increasingly adept at generating text. Such computer programs include, but are not limited to, GPT-3, GPT 3.5, and ChatGPT. For example, one AI program, given a prompt to write a paragraph about the ability of AI to produce text, generated the following paragraph:

“Artificial intelligence (AI) has the ability to write text through the use of natural language processing (NLP) algorithms. These algorithms allow AI systems to analyze and understand human language, and to generate new text that is coherent and flows naturally. While AI is still limited in its ability to write text that is indistinguishable from that written by a human, it has made significant progress in recent years. For example, AI can now write news articles, social media posts, and even complete novels. However, these AI-generated texts are often still distinguishable from those written by humans, as they may lack the nuance and depth of understanding that comes from human experience and emotion. Despite this limitation, AI's ability to write text is still a valuable tool for automating certain types of tasks and generating large amounts of content quickly and efficiently.”

In various contexts, it is valuable to determine whether a text was written by a human as opposed to by an artificial intelligence. These contexts include: education (ensuring that a student personally completed an assignment) and search engine optimization (ensuring that the search engine considers only examples generated by a human as opposed to those generated by a machine).

Various “passive” metrics exist for evaluating whether a text was generated by a human or by an AI. “Passive” means that the analysis is performed solely on the text itself, without considering any information about how the text was generated. One such tool is known as Giant Language Model Test Room (GLTR) and is available at the website http://gltr.io/dist/index.html. The tool analyzes each word of the text, in view of the previous words in the text, and evaluates the likelihood that each new word would be chosen. For highly predictable words, a green background is applied; for the next level, a yellow background is applied, for more unpredictable words, a red background is applied, and for the least predictable words, a violet background is applied. A text with nearly all green or yellow words was likely written by an AI, while a higher percentage of red or violet words suggests that a text was written by a human. Other passive metrics that may be considered when evaluating whether a text was written by an AI include: length of sentences (AI generally produces shorter sentences than humans); repetition of words and phrases; lack of insightful analysis; or use of inaccurate data.

Input logging, known in some contexts as keystroke logging, is a technique for monitoring inputs to a computer during the writing process. During input logging, all inputs to the computer—including, for example, keystrokes, mouse movements, and mouse clicks—are logged with corresponding time stamps. Input logging is used, among other purposes, in order to identify writing strategies and understanding cognitive processes of a writing student.

### SUMMARY OF THE INVENTION

As the ability of AI to approach human-like text continues to increase, the use of “passive” techniques for verifying human authorship is likely to become futile. Simply put, the AI is expected to get “smarter” and learn how to match its writing style even more closely to that of humans. Even the best “passive” technique will no longer be effective for distinguishing between human and AI-generated content. Accordingly, additional techniques are needed in order to verify, with a high probability, that a given text was produced by a human.

The present disclosure introduces a novel “active” technique for verifying whether a text was produced by a human. “Active,” in this context, means that the analysis considers the process of generating the text. The active technique operates by monitoring inputs to a computer during generation of a text. The monitored inputs may include, among others, keystrokes, mouse clicks, redrafting of documents, language used during drafting of documents, or amount of text produced within a given time. Metadata from the monitored inputs are compared to values of the same metadata generated for text created by humans and by artificial intelligence. Based on the comparison, it is possible to determine whether the text was generated by a human or by an artificial intelligence.

According to a first aspect, a method of evaluating whether a text was written by a human or an artificial intelligence is disclosed. The method includes: tracking inputs to a computer during generation of the text; storing metadata from the tracked inputs, said metadata including time of entry of inputs and patterns of entry of the inputs; comparing the metadata to statistical values for time of entry and patterns of entry during composition in human-generated text and in artificial intelligence generated text; and on the basis of the comparing, issuing a determination whether the text was written by a human or by an artificial intelligence.

In another implementation according to the first aspect, the method further includes generating a certificate attesting to human or artificial intelligence authorship. Optionally, the certificate is a digital signature that is appended to the document. Optionally, the certificate comprises a reference within the text to an external document containing an analysis of the metadata.

In another implementation according to the first aspect, the comparing step including performing a specific comparison for a plurality of units of the text. The step of issuing a determination comprises issuing a specific determination for each of the plurality of units.

In another implementation according to the first aspect, the method further includes separately evaluating language patterns in the text, and the step of issuing a determination further comprises issuing a combined determination based on both evaluation of the language patterns and evaluation of the metadata.

In another implementation according to the first aspect, the method further includes evaluating language patterns in the text, comparing the language patterns to published texts, and issuing a determination regarding whether any portion of the text was plagiarized.

In another implementation according to the first aspect, the text is categorized based on at least one of a category of composition or a category of author, and the comparing step includes determining whether the text was written by a human or by an artificial intelligence based on statistical values corresponding to said category of composition or author.

In another implementation according to the first aspect, the comparing step includes determining whether the text was written by a specific person.

In another implementation according to the first aspect, the inputs include one or more of: keystrokes, cursor movements, mouse clicks, and mouse location.

In another implementation according to the first aspect, the inputs include use of word processing editing functions.

In another implementation according to the first aspect, the inputs include languages used during the inputting.

In another implementation according to the first aspect, the time of entry of inputs includes time spent for entry of specific units of text and cumulative time of entry of the text.

In another implementation according to the first aspect, the patterns of entry of inputs comprise patterns of revisions to the text.

In another implementation according to the first aspect, the method further includes determining whether to publish a text on a basis of the determination of whether the text was generated by a human or by an artificial intelligence.

According to a second aspect, a computer program product is disclosed. The computer program product includes instructions stored on a non-transitory computer-readable medium that, when executed by a computer, causes performance of the following steps: tracking inputs to a computer during generation of the text; storing metadata from the tracked inputs, said metadata including time of entry of inputs and patterns of entry of the inputs; comparing the metadata to statistical values for time of entry and patterns of entry during composition in human-generated text and in artificial intelligence generated text; and on the basis of the comparing, issuing a determination whether the text was written by a human or by an artificial intelligence.

### BRIEF DESCRIPTION OF THE DRAWINGS

FIG. 1 illustrates steps in a method for determining whether a text was written by a human or by an artificial intelligence, according to embodiments of the present disclosure;

FIG. 2 illustrates a sequence of tracking inputs to a text, according to embodiments of the present disclosure;

FIG. 3 illustrates tracking of edits to a text using S-notation, according to embodiments of the present disclosure;

FIG. 4 illustrates a certificate appended to the end of a document, according to embodiments of the present disclosure; and

FIG. 5 illustrates a standalone certificate analyzing whether a document was written by a human, including separate analysis of individual units within the text, according to embodiments of the present disclosure.

### DETAILED DESCRIPTION OF THE INVENTION

The present application relates to the field of forensic analysis of text, and more specifically, but not exclusively, to methods and systems for determining whether a text was produced by a human or by an artificial intelligence.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

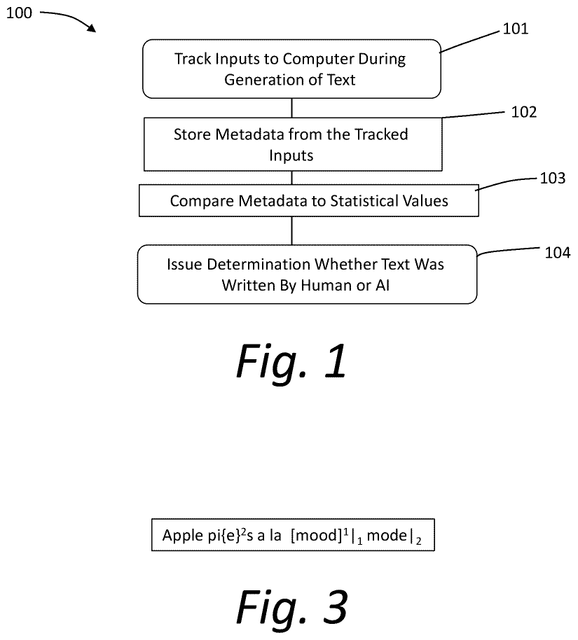

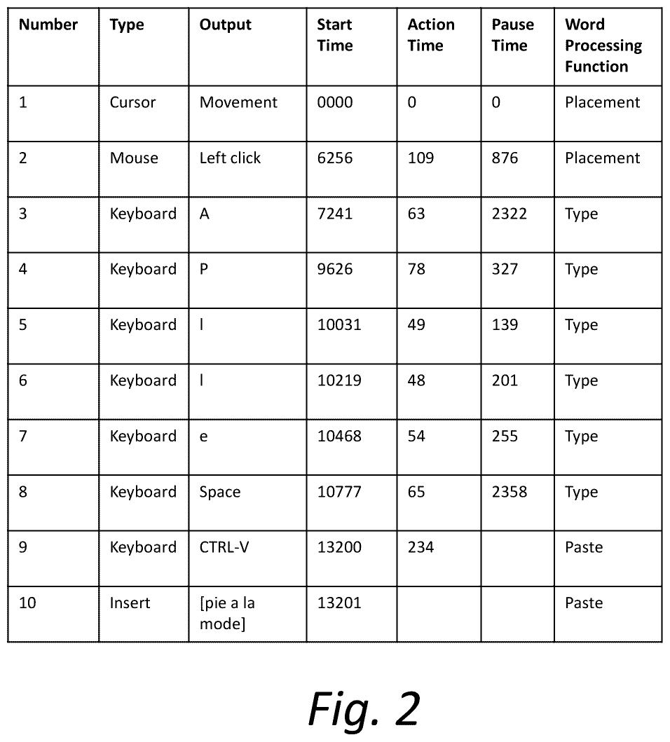

FIG. 1 depicts steps in a method 100 of determining whether a text was written by a human or by an artificial intelligence. Different aspects of this method are illustrated in FIGS. 2-6.

The methods described herein are performed utilizing a computer program. For shorthand, this computer program may be referred to herein as a “human authorship checker” or simply “checker.” The computer program is executed on one or more computing devices. The computing devices each include a processor and a memory, in which the memory is a non-transitory computer-readable medium containing computer-readable instructions, that, when executed by the processor, causes the computing device to perform certain functions as described herein. The computing devices may include, inter alia, a desktop computer, a laptop computer, a tablet computer, a mobile phone, a cloud-based computer, or a virtualized computer.

In exemplary embodiments, performance of the steps described herein may be distributed between different computing devices. A first computer program may be installed on an author's computing device. The first computer program may be configured to monitor inputs to the author's computing device during a drafting process. A second computer program may be installed on a central computing device, for performing analysis of the data collected from the author's computing device. Alternatively, the analysis may be performed by the computer program that is installed on the author's device.

In certain embodiments, the computer program includes a deep neural network. The deep neural network is trained based on a large number of data inputs, regarding the process of drafting texts that are generated by humans, and the process of drafting texts that are generated by AI. The data inputs may be generated using the input tracking program described below, and/or may be aggregated based on data obtained from other input tracking programs. On the basis of this training, the deep neural network is configured to receive data with respect to a newly generated text, and to evaluate the text to determine whether the text was generated by a human or AI. The data inputs may be organized based on categories of texts. For example, typical drafting patterns may vary for fiction or nonfiction, or for legal documents versus expository essays versus computer code. Typical drafting patterns may likewise vary within different cultures, in different languages, and among different types of professionals. The deep neural network may thus be programmed to deliver different output based on a different initial characterization of the texts.

At step 101, the human authorship checker tracks inputs to a computer during generation of a text.

The author's computing device may have various hardware devices for inputting text. The hardware devices may include, inter alia, a keyboard, a mouse, a touch screen, and a voice recorder. The computing device may likewise utilize various software programs for generating and editing text. These software programs may be, for example, word-processing programs. These software programs may be stored on a memory of the computing device itself or may be cloud-based word-processing programs that are accessed from the computer through a network or internet connection. The checker may record inputs to each of these devices or programs. Specifically, the checker may operate within a word processing program; within an operating system, and/or may be installed as part of the hardware device that is used for inputting (e.g. may be hardwired to a keyboard).

Optionally, as a default setting, the author's computing device may not permit access to the checker to track inputs. This may be desirable for reasons of security. Thus, as a first step, the author may enable the checker to begin tracking the inputs.

At step 102, the checker stores metadata from the tracked inputs to the computer during the drafting. This metadata includes time of entry and patterns of entries of the text. Examples of the stored metadata are illustrated at FIG. 2.

FIG. 2 illustrates a log of all the different inputs to a computer during a writing session. In the illustrated example, what is being logged is the placement of a cursor at a certain location on a screen, left clicking with the mouse at that point, typing the word “Apple,” and then pasting the phrase “pie a la mode.” The time for execution of each entry is measured in milliseconds, as well as the time in between different entries. Optionally, the gaps in time may be classified based on whether they occur before words, within words, or after words. These time patterns are generally indicative regarding whether any portion of a text was written by an artificial intelligence. Human drafting is characterized by taking time to process in between words and sentences, while computer drafting typically proceeds at an even pace. Thus, irregular time gaps, especially between words, suggest human authorship, while regular time gaps throughout the authorship are suggestive of AI authorship.

The time-based data may be considered not only for particular words but may also be aggregated for the entire document. The aggregate time-based data may include the total time that a document was open in a word-processing mode (human authorship generally takes significantly longer than AI authorship), as well as distribution of time spent relative to entry of text (for example, if the author wrote 1% of the text in 10 hours and 99% of the text in 10 minutes, this suggests that the last 99% was drafted by an AI).

In addition, the sequence of edits themselves is indicative of the drafting process. The log thus may characterize each input, and monitors the occurrence and frequency of certain inputting and word processing functions. Inputting and word processing functions that may be tracked may include, generally: keystrokes (addition of characters, deletion of characters, pressing of function keys, delay between keystrokes); cursor movements; mouse clicks and their locations; mouse pointer location; and use of word processing tools such as “find,” “replace,” and “grammar checker.”

In addition, information about the writer's computing system and drafting environment may likewise be tracked. This information may include the IP of the author's computer; the software used by the author for word processing; the operating system used on the author's computer; and the languages used on the user's keyboard (which may be useful, for example, for determining if the user has included typographical errors in the wrong language).

The above list of functions that may be tracked is not exhaustive, and any type of input that is relevant to the drafting process, that is known or that may become known, may be considered. In addition, the relative weight given to each input need not be fixed. Consideration of any of these inputs, in any combination and with any relative weight, may be utilized in order to determine whether the text is human or AI-generated.

FIG. 3 illustrates collection of metadata regarding revision of a text, illustrated in the form of S-notation. S-notation is a representation of revisions made to a text during a writing session, including their order and internal structure. Here, the author begins writing a sentence “Apple pi a la mood.” The author realizes that the word “mood” is incorrect, and replaces “mood” with “mode.” The deleted text is surrounded with brackets [ ]. The notation |₁ indicates the order of the correction (i.e., that this correction was entered first), and the superscript [mood]¹ refers to the content of the correction. The author then realized that the word “pi” should have been spelled “pie,” and added the “e” to the word “pi.” This addition is marked in braces { } with the number 2. Of course, the S-notation is necessary only to render the edits intelligible to a human. The checker may simply record and analyze the sequence of inputs without rendering them into S-notation, as discussed in connection with FIG. 2. The sequence of revisions is relevant to whether the text was written by a human or by an AI because, typically, AI-authored text is authored without any corrections whatsoever.

At step 103, the program compares the metadata to statistical values corresponding to the tracked metadata, including particularly time of entry and patterns of inputs. Through a comparison of multiple points of metadata, the program is able to determine whether the text was written by a human or by an artificial intelligence. As discussed above, the comparison may be made on the basis of any selection of the tracked metadata, whether explicitly listed above or not, and in any applied relative weight.

At step 104, the program issues a determination whether the text was written by a human or by an artificial intelligence.

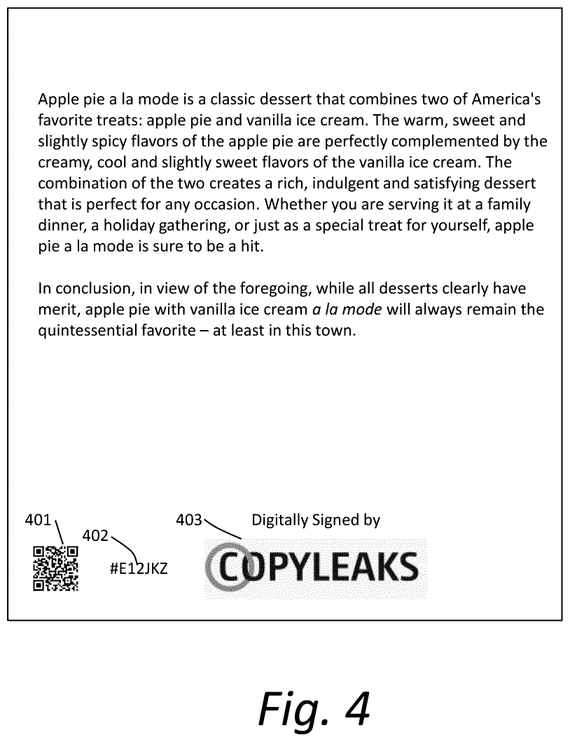

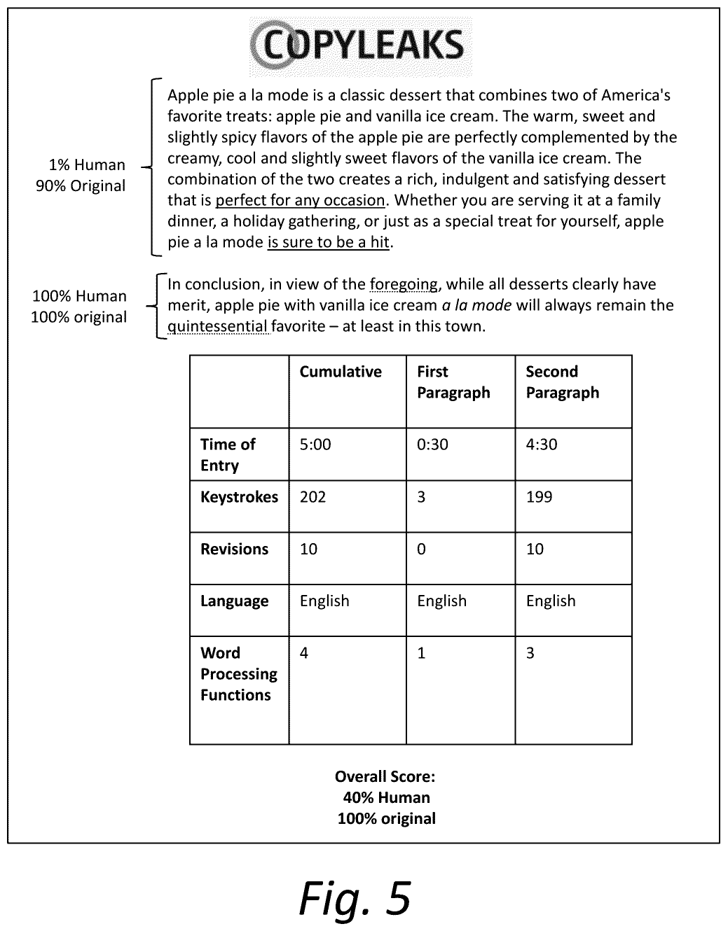

Optionally, the program may further generate a certificate attesting to the authorship of the document as human or AI-generated. Examples as to the form of the certificate are illustrated in FIG. 4 and FIG. 5. In FIG. 4, the final page of an assignment about the dessert “apple pie a la mode” is illustrated. In the given example, the first paragraph was written by an artificial intelligence program, and the second paragraph was written by a human. When the author is ready to submit the text, the author may instruct the program to generate a certificate regarding the authorship. This certificate may be within the document or may be a separate file. In the disclosed embodiments, a QR code 401 is appended to the end of the document. In addition or in the alternative, an alphanumeric label 402 including letters, numbers, or other symbols, may be appended to the end of the document. The QR code 401 or alphanumeric label 402 links to a document that contains a full analysis of the data, such as the document that will be described infra in relation to FIG. 5. The attestation is digitally signed, for example with a private key of the human authorship checker, ensuring that the attestation is reliable and was not the product of tampering. A digital signature 403 may be appended to the end of the document attesting to the authenticity of the code 401 or label 402. This digital signature may also serve to prevent tampering with the document once it has been completed. If desired, the short-form attestation appearing within the document may specifically indicate whether the authorship was by a human or by a machine. Obviously, the attestation and the digital signature, if present, are not limited to the examples depicted herein, and may take any visual form.

FIG. 5 illustrates a schematic analysis regarding the authorship of the text. The report may consist of two sections. In the first section, the report may include a copy of the submitted text, with annotations on the text indicating sections that are indicative of human or AI authorship. The annotations may further delineate, for example in the margins, an overall likelihood as to whether each particular unit of the text was written by a human or by an artificial intelligence. Here, the units are demarcated as paragraphs, but other units may be used, such as sentences, pages, or sections as indicated within the document itself. In the second section, the report may provide a table aggregating relevant statistics regarding the drafting process, such as time of entry of text, number of keystrokes used during the entry, language of entry, and number of word processing editing functions utilized during the entry. The report may further include a cumulative analysis, optionally expressed as a percentage of likelihood, regarding whether the text was written by a human or by an artificial intelligence.

Optionally, the checker may supplement the “active” form of analysis described above with a “passive” evaluation of language patterns in the text, and issue a combined evaluation based on both techniques. This passive evaluation of language patterns may be performed as described in the Background section of the present disclosure. Passive evaluation may be particularly useful for evaluation of sections of text which were introduced via a “paste” function, and for which the origin of the pasted text is unknown. Of course, if the text were copied to the clipboard when the checker was running, the origin of the text could easily be tracked. Regardless, in such instances, the “active” method of analysis may flag the text as potentially machine-generated. The passive method of analysis may reinforce this flagging, because the language patterns in the text may be indicative of AI authorship. The language patterns may alternatively indicate that the origin of the pasted text was likely human. Thus, the combined determination may be based on both evaluations of the language patterns and evaluation of the metadata.

Further optionally, the checker, in addition to evaluating human authorship, may also evaluate the text for plagiarism. To do so, the checker may evaluate language patterns in the text, compare the language patterns to published texts, and issue a determination regarding whether any portion of the text was plagiarized. Plagiarism checkers are well known in the art, and the specific mechanism of operation of a plagiarism checker is beyond the scope of the present disclosure. The plagiarism check may also utilize metadata collected during the writing process as described above. For example, a large chunk of pasted text may be strongly indicative of plagiarized text.

Further optionally, in addition to identifying whether a text was written by a human as opposed to a non-human, the program may specifically determine whether the text was written by a specific person. This functionality is especially useful in scenarios in which the program may be trained on specific texts produced by a particular author. Similarly, the program may be trained on texts produced by categories of authors with certain types of training (e.g., a particular educational degree or professional license) in order to evaluate whether the type of writing and the process of writing matches the typical parameters for those categories of texts and authors.

In the foregoing description, the human authorship checker was described as a standalone program. In alternative embodiments, the human authorship checker may be a plugin that may be incorporated into other software programs. These software programs may be, for example, word processing editing programs. In addition, the human authorship checker may be integrated into a suitable program that utilizes the output of the checker. For example, a content moderation may determine whether a text should be published on an online platform on the basis of whether the text was generated by a human or AI. The term “publish” is used in a broad sense and may refer to any form of publicizing or calling attention to a text. Likewise, a search engine optimization tool, or a social media platform, may choose whether to prioritize certain content on the basis of whether the text was generated by a human or by an AI.

What is claimed is:

1. A method of evaluating whether a text was written by a human or an artificial intelligence, comprising:
tracking inputs to a computer during generation of the text;
storing metadata from the tracked inputs, said metadata including time of entry of inputs and patterns of entry of the inputs;
comparing the metadata to statistical values for time of entry and patterns of entry during composition in human-generated text and in artificial intelligence generated text; and
on the basis of the comparing, issuing a determination whether the text was written by a human or by an artificial intelligence.

2. The method of claim 1, further comprising generating a certificate attesting to human or artificial intelligence authorship.

3. The method of claim 2, wherein the certificate is a digital signature that is appended to the document.

4. The method of claim 2, wherein the certificate comprises a reference within the text to an external document containing an analysis of the metadata.

5. The method of claim 1, wherein the comparing step comprises performing a specific comparison for a plurality of units of the text, and wherein the step of issuing a determination comprises issuing a specific determination for each of the plurality of units.

6. The method of claim 1, wherein the text is categorized based on at least one of a category of composition or a category of author, and the comparing step comprises determining whether the text was written by a human or by an artificial intelligence based on statistical values corresponding to said category of composition or author.

7. The method of claim 1, wherein the comparing step comprises determining whether the text was written by a specific person.

8. The method of claim 1, further comprising separately evaluating language patterns in the text, and the step of issuing a determination further comprises issuing a combined determination based on both evaluation of the language patterns and evaluation of the metadata.

9. The method of claim 1, further comprising evaluating language patterns in the text, comparing the language patterns to published texts, and issuing a determination regarding whether any portion of the text was plagiarized.

10. The method of claim 1, wherein the inputs comprise one or more of: keystrokes, cursor movements, mouse clicks, and mouse location.

11. The method of claim 1, wherein the inputs comprise use of word processing editing functions.

12. The method of claim 1, wherein the inputs comprise languages used during the inputting.

13. The method of claim 1, wherein the time of entry of inputs comprises both time spent for entry of specific units of text and cumulative time of entry of the text.

14. The method of claim 1, wherein the patterns of entry of inputs comprise patterns of revisions to the text.

15. The method of claim 1, further comprising determining whether to publish a text on a basis of the determination of whether the text was generated by a human or by an artificial intelligence.

16. A computer program product comprising instructions stored on a non-transitory computer-readable medium that, when executed by a computer, causes performance of the following steps:
tracking inputs to a computer during generation of the text;
storing metadata from the tracked inputs, said metadata including time of entry of inputs and patterns of entry of the inputs; and,
comparing the metadata to statistical values for time of entry and patterns of entry during composition in human-generated text and in artificial intelligence generated text; and
on the basis of the comparing, issuing a determination whether the text was written by a human or by an artificial intelligence.
